(19) United States
(12) Patent Application Publication
(10) Pub. No.: US 2019/0311644 A1
(43) Pub. Date: Oct. 10, 2019

(54) COMPUTER SYSTEM AND PROGRAM FOR ASSISTING GRADING OF EXAMINATION PAPERS

(71) Applicant: NICHINOKEN INC., Kanagawa (JP)

(72) Inventor: Mikio Takagi, Kanagawa (JP)

(21) Appl. No.: 16/468,978

(22) PCT Filed: Oct. 25, 2017
(86) PCT No.: PCT/JP2017/038501

§ 371 Date: Jun. 12, 2019

(30) Foreign Application Priority Data
Dec. 12, 2016 (JP) 2016240105

(51) Int. Cl. G09B 7/04; G09B 5/00

(52) U.S. Cl. CPC G09B 7/04; G09B 5/00

(57) ABSTRACT

In the system of the present invention, a grader can perform “grading-suspending” when he/she wavers in judgement as to whether an examinee's answer is correct (∘) or incorrect (x). This is achieved by, for example, giving a “grading-suspending flag” to the answer for which “grading-suspending” has been performed by the grader. Further, in the system of the present invention, when a grader wants to give a comment to an examinee's answer, the grader can designate the examinee's answer and request to “give a comment” instead of giving a comment to the examinee's answer by himself/herself. This is achieved by, for example, giving a “comment-requesting flag” to the answer for which the grader requested to “give a comment”.

### TECHNICAL FIELD

The present invention relates to a computer system and program for assisting grading of answers to examination.

### BACKGROUND ART

A system for assisting grading of answers to examination has been conventionally known (Patent Literature 1). The top priority issue in such a system is improving the efficiency in grading because it is required to perform grading as soon as possible after conducting a test. However, when improving the efficiency in grading is treated as a top priority issue, the quality of the test is likely to be lowered.

### BACKGROUND ART

### Patent Literature

### [PTL 1] Japanese Laid-Open Publication No. 2014-16669

### SUMMARY OF INVENTION

### Technical Problem

The objective of the present invention is to provide a computer system and a program enabling both improving the efficiency in grading and improving the quality of learning in grading.

### Solution to Problem

The computer system for assisting grading of answers to examination of the present invention comprises a means enabling a grader to make a judgement as to whether an answer of an examinee is correct or incorrect, and a means enabling a grader to make temporary judgement not to judge whether an answer of an examinee is correct or incorrect.

In one embodiment of the present invention, a computer system for assisting grading of answers to examination further comprises a means of extracting the answer for which the grader made the temporary judgement, and a means enabling judging whether the answer extracted by the extracting means is correct or incorrect.

In one embodiment of the present invention, a computer system for assisting grading of answers to examination further comprises a means of indicating judgement as to whether the answer for which the grader made the temporary judgement is correct or incorrect to the grader.

In one embodiment of the present invention, a computer system for assisting grading of answers to examination further comprises a means of extracting the answer for which the grader made the temporary judgement, and a means enabling giving a comment for the examinee to the answer for which the grader made the temporary judgement.

In one embodiment of the present invention, a computer system for assisting grading of answers to examination further comprises a means of processing the answer to which the comment for the examinee has been given as a correct answer.

In one embodiment of the present invention, a computer system for assisting grading of answers to examination further comprises a means enabling a grader to judge that there is no answer of an examinee.

In the program for assisting grading of the present invention is executed in a computer system, wherein the computer system comprises a controlling unit, and wherein the program, when executed, causes the controlling unit to perform processing comprising: enabling a grader to make judgement as to whether an answer of an examinee is correct or incorrect; and enabling a grader to make judgement not to judge whether an answer of an examinee is correct or incorrect.

### Advantageous Effects of Invention

According to the present invention, it is possible to provide a computer system and a program enabling both improving the efficiency in grading and improving the quality of learning in grading.

### BRIEF DESCRIPTION OF DRAWINGS

FIG. 1 shows one example of a flow of processing from conducting of a test to displaying of a test result.

FIG. 2A shows one example of a configuration of a computer system 10 which executes the processing from conducting of a test to displaying of a test result described with reference to FIG. 1.

FIG. 2B shows one example of a configuration of a grader terminal device 40.

FIG. 3 shows one example of a configuration of grading result data stored in a database unit 70.

FIG. 4A shows one example of a flow of data in processing executed in a computer system 10.

FIG. 4B shows one example of a flow of data in processing executed in a computer system 10.

FIG. 5 shows one example of a flow of processing of flagged data executed in Step S104-3.

FIG. 6 shows one example of an answer sheet 80 of a test.

FIG. 7 shows one example of a screen 110 displayed on a display of a grader terminal device 40.

FIG. 8 shows one example of a screen 150 displayed on a display of a grader terminal device 40.

FIG. 9 shows one example of a screen 160 displayed on a display of a grader terminal device 40.

### DESCRIPTION OF EMBODIMENTS

The embodiments of the present invention are described hereafter with reference to the drawings.

### 1. A Flow of Processing from Conducting of a Test to Displaying of a Test Result

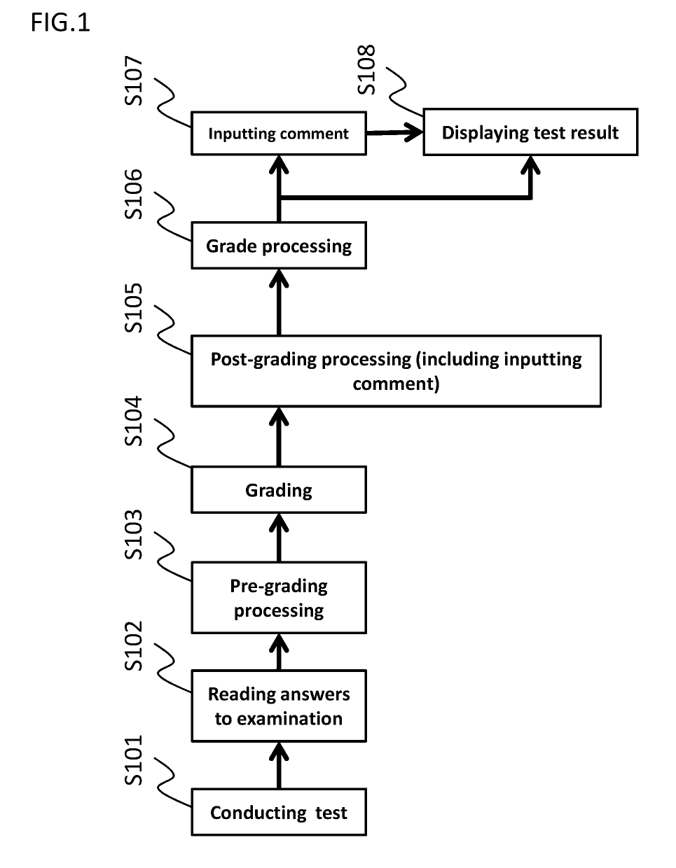

FIG. 1 shows one example of a flow of processing from conducting of a test to displaying of a test result.

In Step S101, a test is conducted. The test is conducted using, for example, answer sheets in each test site.

In Step S102, answer sheets are read. This is performed by, for example, utilizing a scanner device installed in each test site to scan the answer sheets collected in each test site after the test is conducted in each test site. As a result, image data of the answer sheets is created.

In Step S103, pre-grading processing is performed. The pre-grading processing herein refers to processing which is performed before grading in order to improve the efficiency in grading. The pre-grading processing includes, for example, processing for enabling a grader to collectively grade all examinees' answers for each question, and processing for enabling a grader to rearrange all examinees' answers in accordance with a predetermined key.

In Step S104, grading is performed. A grader judges whether an examinee's answer is correct (∘), incorrect (x), or there is no answer (∨). Points are set for each question on the answer sheets. It is possible to determine scores corresponding to each answer sheet by summing up points of questions with correct answers of the answer sheet.

A grader can, for example, collectively grade all examinees' answers for each question, or the grader can rearrange all examinees' answers in accordance with a predetermined key and then grade the answers. For example, the grader may rearrange all examinees' answers in descending order (or ascending order) of a deviation value in the past test in accordance with a key related to the past (for example, a deviation value in the past test) and then grade the answers, or may rearrange all examinees' answers in descending order (or ascending order) of an answer-density of an answer sheet (a percentage of blanks filled with an answer on an answer sheet) in accordance with a key related to the present (for example, an answer-density of an answer sheet) and then grade the answers. As a result, the grader can grade answers in a almost constant rhythm, which thereby improves the efficiency in grading.

A grader sometimes wavers in judgement as to whether an examinee's answer is correct (∘) or incorrect (x) when grading. In such a case, when the grader wavers in judgement as to whether the answer is correct or incorrect and goes into deep thought, the efficiency of grading is decreased because grading is interrupted. However, the inventor of the present invention considered that it is “good” rather than “bad” that a grader wavers in judgement as to whether an answer is correct or incorrect. The inventor considered as follows: a grader wavering in judgement as to whether an answer is correct or incorrect does not indicate that the grader is incompetent but rather indicates that the grader is highly competent; what is helpful for improving a grader's ability is to respect such wavering, which leads to improvement of the quality of learning in grading. The inventor of the present invention also thought that those who perform grading without wavering in judgement as to whether an answer is correct or incorrect while putting emphasis on the efficiency in grading cannot be trusted. Thus, the inventor of the present invention invented a system which enables both improving the efficiency in grading and improving the quality of learning in grading while utilizing a grader's ability of “wavering in judgement as to whether an answer is correct or incorrect”.

In the system of the present invention, a grader can perform “grading-suspending” when the grader wavers in judgement as to whether an examinee's answer is correct (∘) or incorrect (x). “Grading-suspending” means suspending judgement as to whether an answer is correct or incorrect as it is not possible to immediately judge whether the answer is correct or incorrect. This is achieved by, for example, giving a “grading-suspending flag” to an answer for which “grading-suspending” has been performed by the grader.

According to the system of the present invention, when a grader wavers in judgement as to whether an answer is correct or incorrect, the grader can proceed to grading of the next answer without interrupting grading by performing “grading-suspending”. This improves the efficiency in grading. The answer for which “grading-suspending” has been performed is subjected to post-grading processing in Step S105. In the post-grading processing, the answer for which “grading-suspending” has been performed can be graded by a grader different from the grader who performed “grading-suspending” (for example, a superior grader). In this manner, a grader different from the grader who performed “grading-suspending” (for example, a superior grader) finally judges whether the answer for which “grading-suspending” has been performed is correct (∘) or incorrect (x) to enable performing proper grading. As a result, the quality of grading is maintained and thus the quality of a test is maintained. Further, such final judgement is fed back to the grader who performed “grading-suspending”, which enables the grader who performed “grading-suspending” to learn judgement finally made by another grader, and said grader is given an opportunity to improve the quality of his/her grading. In this manner, according to the system of the present invention, it is possible to both improve the efficiency in grading and improve the quality of learning in grading.

Further, a grader sometimes wants to give a comment to an examinee's answer during grading. For example, a grader sometimes wants to treat an examinee's answer as correct while giving a comment when the answer is too good to be deemed as incorrect although the answer is not completely correct. In such a case, the system of the present invention enables treating the examinee's answer as correct on the condition of giving a comment. The comment given to the examinee's answer is fed back to the examinee, thereby the examinee is given an opportunity of “looking back”, which is important for improving his/her academic ability. However, when the grader gives a comment to the examinee's answer during grading, the efficiency of grading is decreased because grading is interrupted.

In the system of the present invention, when a grader wants to give a comment to an examinee's answer, the grader can designate the examinee's answer to request to “give a comment” instead of giving a comment to the examinee's answer by himself/herself. For example, when the examinee's answer is too good to be deemed as incorrect although the answer is not completely correct, the grader can designate the examinee's answer to request to “give a comment”. This is achieved by, for example, giving a “comment-requesting flag” to the answer for which the grader requested to “give a comment”. When the grader himself/herself who requested to give a comment or another grader actually gives a comment to the answer for which the request to “give a comment” has been made, the answer is processed as a correct answer, and the comment given to the answer is fed back to the examinee, thereby the examinee is given an opportunity of “looking back”, which is important for improving his/her academic ability. Meanwhile, when the grader himself/herself who requested to give a comment or another grader cannot give a comment to the answer for which the request to “give a comment” has been made, the answer is processed as an incorrect answer.

According to the system of the present invention, when a grader wants to give a comment to an examinee's answer, the grader can proceed to grading of the next answer without interrupting grading by designating the examinee's answer and requesting to “give a comment”. This improves the efficiency in grading. The answer for which the request to “give a comment” has been made is subjected to post-grading processing in Step S105. In the post-grading processing, the grader himself/herself who made the request or another grader can give a comment to the answer for which the request to “give a comment” has been made. This improves the quality of learning of the examinee. In this manner, according to the system of the present invention, it is possible to both improve the efficiency in grading and improve the quality of learning of the examinee.

In Step S106, grade processing is performed. The grade processing is performed after grading all answers to examination. Grade data comprising each examinee's scores is stored, for example, in a database of a basic system.

In Step S107, a comment is inputted. Such a comment is inputted by, for example, a teacher in charge of the class of an examinee. For example, the teacher in charge of the class may input a comment for each question of the examinee's answers to examination, or the teacher in charge of the class can give a comment to an answer for which request to “give a comment” was made but to which a comment has not been given yet. Such a comment is fed back to the examinee. However, even when the teacher in charge of the class gives a comment to the answer, the answer will not be processed as a correct answer because the grade processing of Step S106 is already completed at the time of Step S107. The comment given to the answer by the teacher in charge of the class is stored, for example, in a database of a basic system while being associated with grade data.

In Step S108, a test result comprising grade data or a comment of each examinee stored in a database of a basic system is displayed to each examinee. For example, the test result is displayed on a screen of a terminal device of each examinee.

### 2. A Configuration of a Computer System

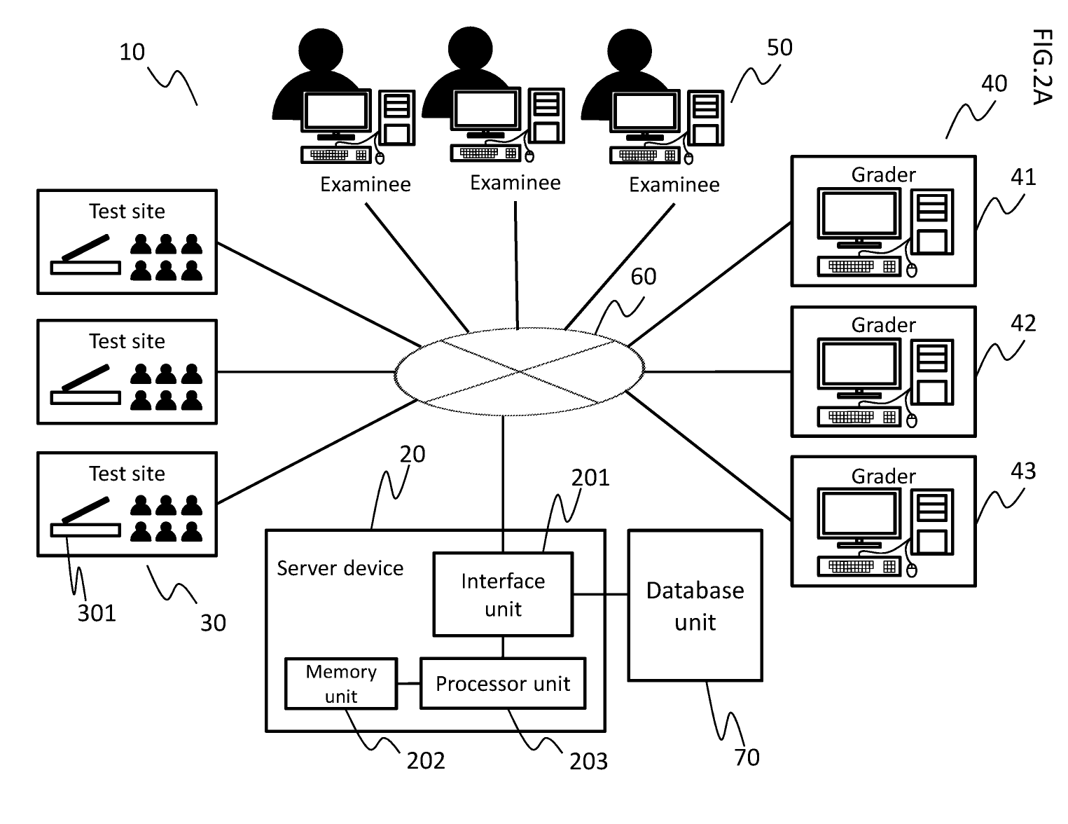

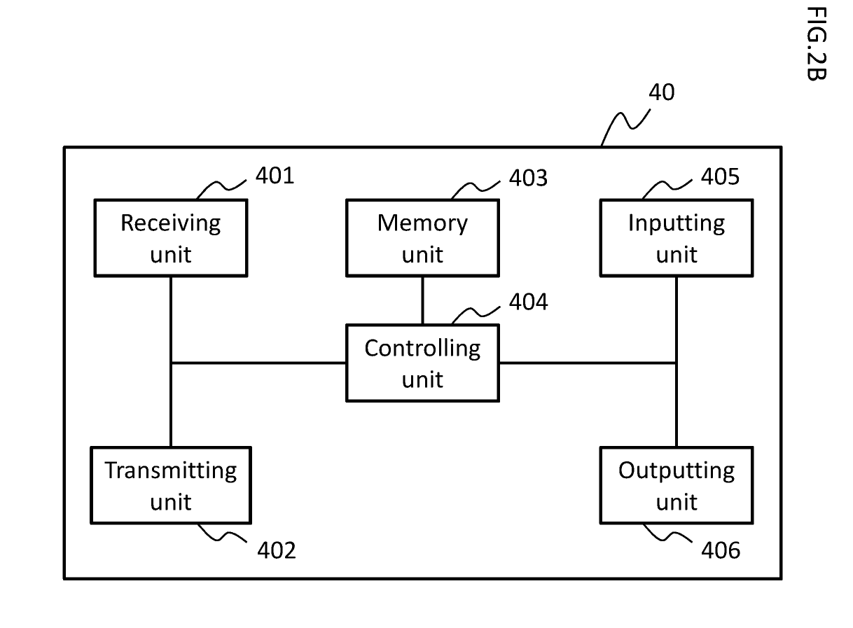

FIG. 2A shows one example of a configuration of a computer system 10 which executes the processing from conducting of a test to displaying of a test result described with reference to FIG. 1.

The computer system 10 comprises: a server device 20; a plurality of scanner devices 301 installed in a plurality of test sites 30; a plurality of grader terminal devices 40; and a plurality of examinee terminal devices 50. The plurality of scanner devices 301, the plurality of grader terminal devices 40, and the plurality of examinee terminal devices 50 are configured to be connectable to the server device 20 via Internet 60.

The server device 20 comprises: an interface unit 201, a memory unit 202, and a processor unit 203.

The interface unit 201 controls communication with the plurality of scanner devices 301, the plurality of grader terminal devices 40, and the plurality of examinee terminal devices 50.

The memory unit 202 stores a program required for execution of processing, data required for execution of the program, and the like. For example, the memory unit 202 stores a program for realizing the pre-grading processing

(Step S103 in FIG. 1) or the grade processing (Step S106 in FIG. 1). Further, the memory unit 202 stores a program which realizes processing for extracting an answer to which a “grading-suspending flag” or a “comment-requesting flag” was given. In this regard, it does not matter how the programs are stored in the memory unit 202. For example, the programs may be already pre-installed in the memory unit 202, or the programs may be installed in the memory unit 202 by being downloaded via a network such as the Internet 60 or may be installed in the memory unit 202 via a storage medium such as an optical disk and USB.

The processor unit 203 controls the operation of the whole server device 20. The processor unit 203 reads out a program stored in the memory unit 202 and executes the program, which enables the server device 20 to function as a device executing a desired step.

A database unit 70 is connected to the server device 20. The database unit 70 stores image data of answer sheets received from the test sites 30, answer image data created by pre-grading processing, grading result data received from the grader terminal devices 40, grade data determined based on the grading result data, a comment given by a grader, a comment given by a teacher in charge of a class, or the like. Further, the database unit 70 may store an examinee's grade as accumulated data.

Although the database unit 70 is provided outside the server device 20 in the example shown in FIG. 2A, the present invention is not limited to the above. It is also possible to provide the database unit 70 inside the server device 20. The configuration of the database unit 70 is not limited to a particular hardware configuration. For example, the database unit 70 may be composed of a single hardware component, or may be composed of a plurality of hardware components. For example, the database unit 70 may be configured as an external hard disk device of the server device 20, or may be configured as a storage on a cloud connected via a network.

The plurality of scanner devices 301 are installed in the plurality of test sites 30. The plurality of scanner devices 301 are used for scanning answer sheets collected from the plurality of test sites 30 after a test is conducted. Image data of the answer sheets is created by scanning the answer sheets. When the answer sheets are scanned, an examinee number or name written on the answer sheets may be read. This makes it possible to automatically give an examinee ID to the image data of each answer sheet. As a result, it is possible to make each image data (for example, image data for each question) comprised in the image data of the answer sheets correspond to an examinee in one-to-one relationship. The examinee ID may be the same as or different from the examinee number. The image data of each answer sheet to which the examinee ID has been given is transmitted to the server device 20 via the Internet 60, and stored in the database unit 70 connected to the server device 20.

Each of the plurality of grader terminal devices 40 is used by a grader. For example, the plurality of grader terminal devices 40 include a grader terminal device 41 used by a first grader, a grader terminal device 42 used by a second grader, and a grader terminal device 43 used by a third grader.

FIG. 2B shows one example of a configuration of the grader terminal devices 40.

A grader terminal device 40 can be any type of a computer comprising a receiving unit 401, a transmitting unit 402, a memory unit 403, a controlling unit 404, an inputting unit 405, and an outputting unit 406. An inputting device is connected to the inputting unit 405. The inputting device is, for example, a keyboard, mouse, touch panel, microphone, or the like. The outputting unit 406 is, for example, a display, speaker, or the like.

The receiving unit 401 is configured to receive data. It does not matter how the receiving unit 401 receives the data. For example, the receiving unit 401 may receive data via the Internet 60, or may receive data read out from a storage medium storing the data. For example, the receiving unit 401 receives answer image data created by the server device 20 executing pre-grading processing. Further, the receiving unit 401 receives flagged data extracted by the server device 20 executing extraction processing.

The transmitting unit 402 is configured to transmit data. It does not matter how the transmitting unit 402 transmits the data. The transmitting unit 402 may transmit data via the Internet 60, or may store data in a storage medium and provide the data outside the grader terminal device 40. For example, the transmitting unit 402 transmits grading result data stored in the memory unit 403 to the server 20.

The memory unit 403 stores a program required for execution of processing of the grader terminal device 40, data required for execution of the program, and the like. The memory unit 403 stores grading result data. The memory unit 403 may store a program for causing the controlling unit 404 to execute processing for assisting grading of answers to examination. The memory unit 403 can be implemented by any storage means.

The controlling unit 404 controls the operation of the whole grader terminal device 40. A program stored in the memory unit 403 is read out and the program is executed. This enables the grader terminal device 40 to function as a device which executes a desired step.

The inputting unit 405 is configured to receive an input via an inputting device. The input received by the inputting unit 405 includes an input indicating judgement that an answer is correct (∘), an input indicating judgement that an answer is incorrect (x), an input indicating judgement that there is no answer (∨), an input indicating judgement that grading of an answer is suspended (“grading-suspending flag”), and an input indicating judgement that it is requested to give a comment to an answer (“comment-requesting flag”). Further, the input received by the inputting unit 405 includes a comment for an answer. It does not matter how the inputting unit 405 receives the input. For example, the inputting unit 405 may receive an input via a keyboard, may receive an input via a touch panel, or may receive an input by voice via a microphone.

The outputting unit 406 is configured to present data to a grader who uses the grader terminal device 40. It does not matter how the outputting unit 406 presents the data. For example, the outputting unit 406 may display a grading display screen on a display to present data, or may present data by reproducing data reading from a speaker.

For each answer image data presented by the outputting unit 406, an input indicating judgement that an answer is correct (∘), an input indicating judgement that an answer is incorrect (x), an input indicating judgement that there is no answer (∨), a “grading-suspending flag”, or a “comment-requesting flag” received by the inputting unit 405 is stored in the memory unit 403 as grading result data while being associated with each answer image data. Further, for the flagged data presented by the outputting unit 406, an input indicating judgement that an answer is correct (∘), an input indicating judgement that an answer is incorrect (x), or a comment for an answer received by the inputting unit 405 is stored in the memory unit 403 as grading result data while being associated with each answer image data.

With reference to FIG. 2A again, each of the plurality of examinee terminal devices 50 is used by an examinee. Each of the plurality of examinee terminal devices 50 is configured to receive a test result comprising grade data or a comment from the server device 20 via the Internet 60. Furthermore, each of the plurality of examinee terminal devices 50 is configured to be able to display the received test result. Alternatively, a printing of the test result may be distributed to each examinee instead of displaying the test result on a screen of the examinee terminal devices 50. It does not matter how the test result is presented to an examinee. Since the configuration of the examinee terminal devices 50 is similar to the configuration of the grader terminal devices described above with reference to FIG. 2B, the detailed description of the configuration of the examinee terminal devices 50 is herein omitted.

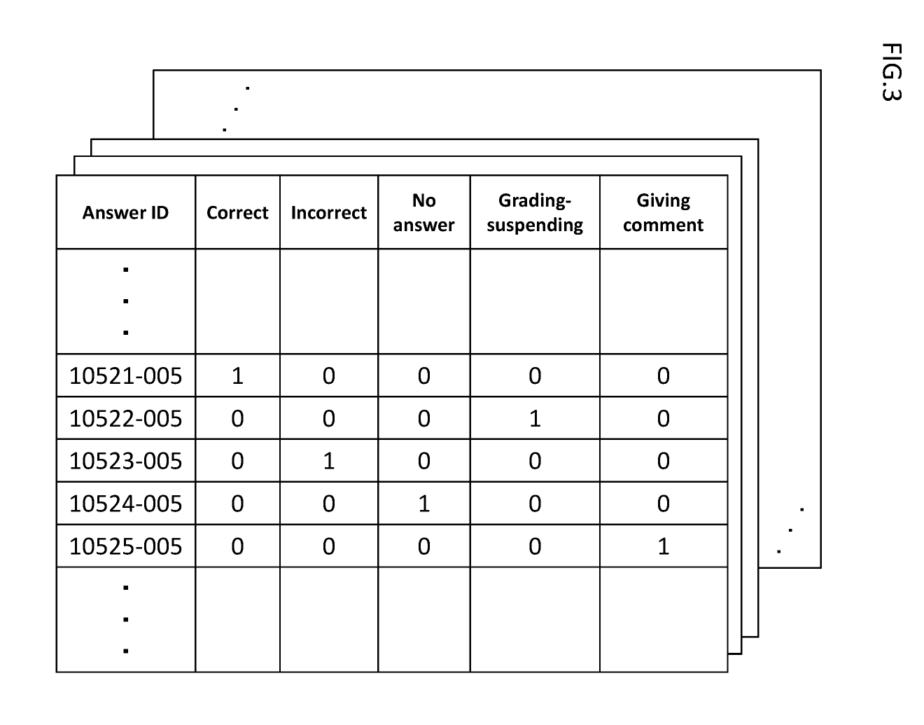

FIG. 3 shows one example of a configuration of grading result data stored in a database unit 70.

The grading result data comprises an answer ID, a value indicating a correct answer, a value indicating an incorrect answer, a value indicating no answer, a value indicating a grading-suspending flag, a value indicating a comment-requesting flag. For example, the answer ID comprises an examinee ID and a question number. In FIG. 3, the answer ID is an identifier for identifying an examinee's answer. For example, the answer ID being “10521-005” indicates an answer for question No. 5 of an examinee with examinee ID 10521. The value which indicates a correct answer corresponding to answer ID “10521-005” being 1 indicates that a grader judged that the answer for question No. 5 of the examinee with examination ID 10521 was correct. The value which indicates a grading-suspending flag corresponding to answer ID “10522-005” being 1 indicates that a grader keeps the answer for question No. 5 of an examinee with examinee ID 10522 in a “grading-suspending” state. The value which indicates an incorrect answer corresponding to answer ID “10523-005” being 1 indicates that a grader judged that the answer for question No. 5 of an examinee with examinee ID 10523 was incorrect. The value which indicates no answer corresponding to answer ID “10524-005” being 1 indicates that a grader judged that there is no answer for question No. 5 of an examinee with examinee ID 10524. The value which indicates a comment-requesting flag corresponding to answer ID “10525-005” being 1 indicates that a grader keeps the answer for question No. 5 of an examinee with examinee ID 10525 in a state wherein “it is requested to give a comment”.

The configuration of the grading result data shown in FIG. 3 is one example. The grading result data can be stored in the database unit 70 in any configuration as long as the grading result data indicates whether an examinee's answer is correct, incorrect, no answer, in a “grading-suspending” state, or in a state wherein “it is requested to give a comment”.

Furthermore, the components of each device shown in FIGS. 2A and 2B may be composed of a single hardware component, or may be composed of a plurality of hardware components. The configuration of each device shown in FIGS. 2A and 2B is not limited to a particular hardware configuration.

In the embodiment shown in FIG. 2A, the plurality of scanner devices 301, the plurality of grader terminal devices 40, and the plurality of examinee terminal devices can be connected to the server device 20 via the Internet 60. However, the present invention is not limited to the above. It is also possible to use any type of a network instead of the Internet 60. Furthermore, a configuration of electrically coupling the server device 20 and the plurality of grader terminal devices 40 without via the Internet 60 and an any alternative network also remains within the scope of the present invention. Further, an integrated system in which both of the function of the server device 20 and the function of the grader terminal devices 40 are integrally incorporated may be constructed. Such an integrated system also remains within the scope of the present invention.

In the embodiment shown in FIG. 2A, an example wherein a test is conducted in the plurality of test sites 30 was described. However, the present invention is not limited to the above. A test may be conducted in a single test site. Furthermore, although an example of using the scanner devices 301 installed in the test sites to scan answer sheets was described, the present invention is not limited to the above. For example, answer sheets collected from all test sites may be gathered in one place such as a test head office and then collectively scanned without scanning the answer sheets collected from each test site in each test site. Furthermore, although an example of scanning answer sheets was described on the assumption that an examinee writes an answer on a paper answer sheet, the present invention is not limited to the above. For example, when each examinee uses a terminal device to input an answer to an electronic answer sheet, the answer sheet does not need to be scanned, and data of the answer sheet to which the answer has been inputted may be transmitted to the server device 20 via the network 60 and thereby stored in the database unit 70 connected to the server device 20. As long as data indicating each examinee's answer is stored in the database unit, it does not matter how such data is created. Further, as long as such data indicates each examinee's answer, the format of the data also does not matter.

In the embodiment shown in FIG. 2B, the following example was described: the inputting unit 405 receives an input including an input indicating judgement that an answer is correct (∘), an input indicating judgement that an answer is incorrect (x), an input indicating judgement that there is no answer (∨), an input indicating judgement that grading of an answer is suspended (“grading-suspending flag”), and an input indicating judgement that it is requested to give a comment to an answer (“comment-requesting flag”). However, the present invention is not limited to the above. The inputting unit 405 has to, at least, receive any of an input indicating judgement that an answer is correct (∘), an input indicating judgement that an answer is incorrect (x), and an input indicating temporary judgement that judgement as to whether an answer is correct (∘) or incorrect (x) is not made. That is, the inputting unit 405 may not have to distinguish the “grading-suspending flag” and “comment-requesting flag” in receiving. The inputting unit 405 only has to receive a flag indicating that judgement as to whether an answer is correct or incorrect is not made. When the flag is a flag indicating that judgement as to whether an answer is correct or incorrect is not made and is a flag which does not indicates whether the flag is a grading-suspending flag or a comment-requesting flag, a succeeding grader judges whether the inputted flag is a flag intending a grading-suspending flag or a flag intending a comment-requesting flag.

### 3. Processing in a Computer System

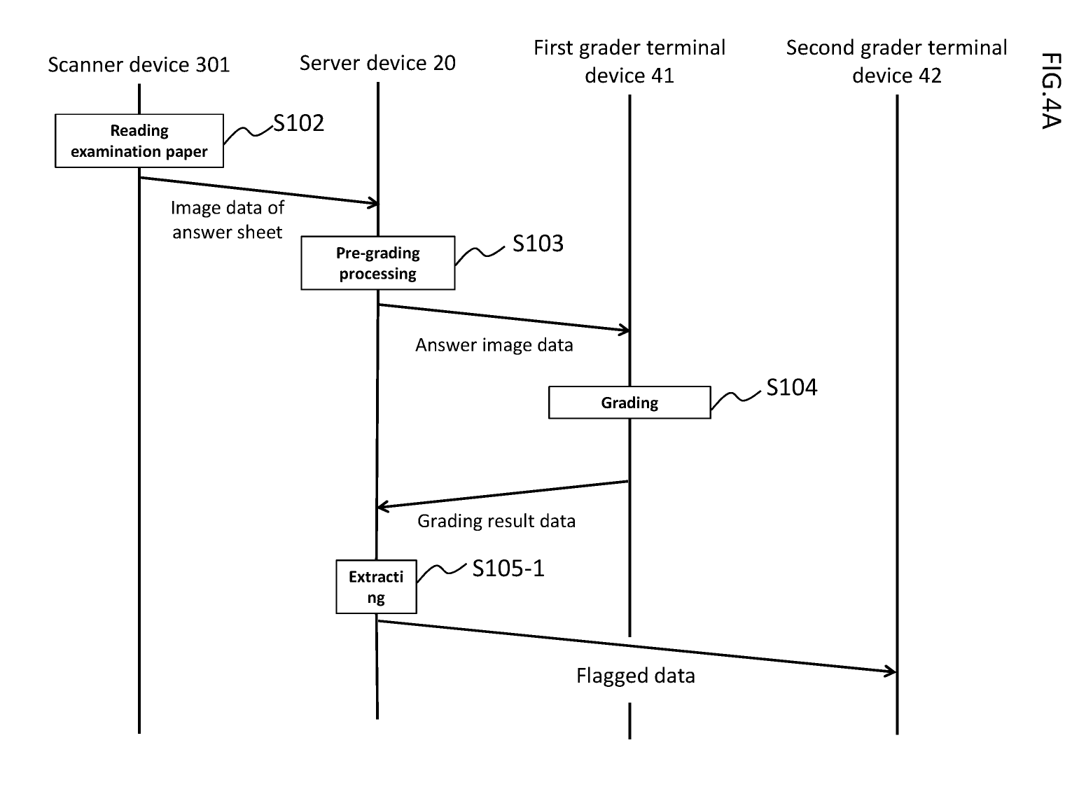

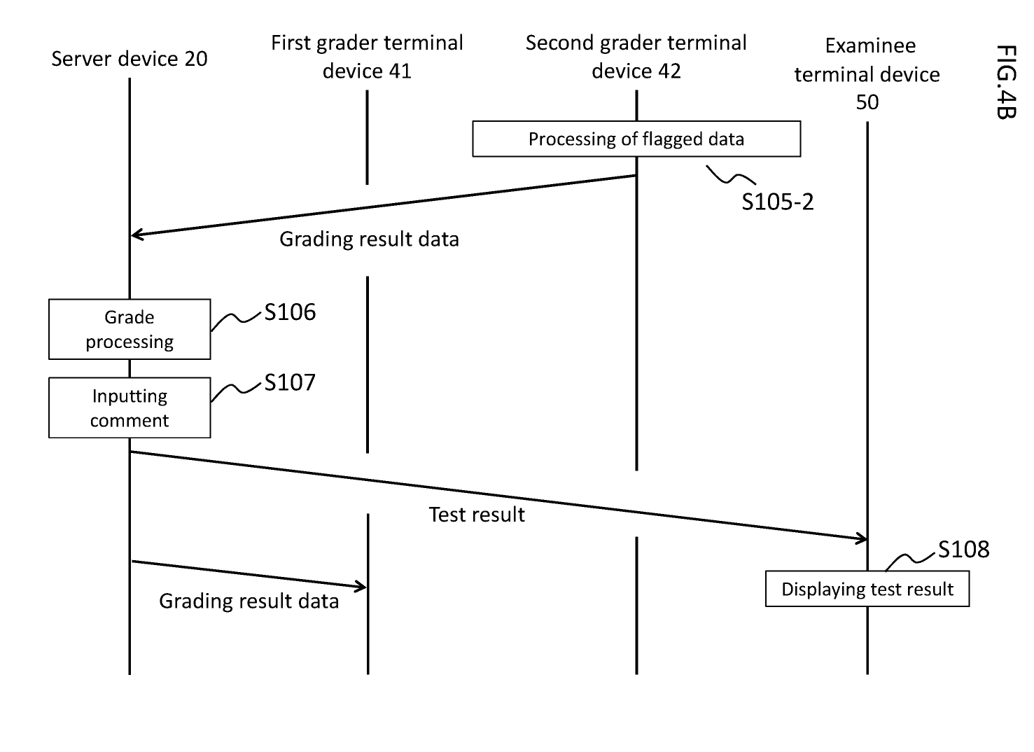

FIGS. 4A and 4B show one example of a flow of data in processing executed in a computer system 10. In the example shown in FIGS. 4A and 4B, data is exchanged between a scanner device 301 in a test site 30, a server device 20, a first grader terminal device 41, a second grader terminal device 42, and an examinee terminal device 50.

In Step S102, the scanner device 301 reads answer sheets of a test. As a result, image data of the answer sheets is created. For example, when doing so, an examinee ID is given to each image data by receiving an examinee number of the answer sheets, thereby each image data is made correspond to an examinee in one-to-one relationship. The examinee ID may be the same as or different from the examinee number. A method for receiving the examinee number does not matter. For example, an examinee number which is manually inputted may be received, or an examinee number which is read from the answer sheets and subjected to character recognition processing may be received. The created image data of the answer sheets is transmitted to the server device 20. The image data of the answer sheets transmitted to the server device 20 is stored in a database unit 70 connected to the server device 20.

In Step S103, the server device 20 performs pre-grading processing. The pre-grading processing is, for example, processing wherein the server device 20 extracts answer image data for each question from the image data of the answer sheets and gives an answer ID to each answer image data, thereby each answer image data is made correspond to an examinee and a question number in one-to-one relationship. For example, the server device 20 gives answer ID 10521-005 to an answer for question No. 5 of an examinee with examinee ID 10521. The server device 20 stores the answer image data to which the answer ID has been given in the database unit 70. The answer image data is then transmitted to the first grader terminal device 41. The first grader terminal device 41 receiving the answer image data which was subjected to the pre-grading processing stores the answer image data in a memory unit 403 of the first grader terminal device 41.

In Step S104, grading is performed by the first grader terminal device 41 receiving an input indicating judgement as to whether an answer is correct or incorrect from a first grader. Before receiving the input indicating judgement as to whether an answer is correct or incorrect from the first grader, an outputting unit 406 of the first grader terminal device 41 displays a correct-or-incorrect judgement screen which enables the first grader to judge whether an answer is correct or incorrect. It does not matter how each answer image data is displayed on the correct-or-incorrect judgement screen. Each answer image data may be arranged for each question to display the data on the correct-or-incorrect judgement screen, or may be arranged for each examinee to display the data on the correct-or-incorrect judgement screen. Alternatively, each answer image data may be rearranged in a particular order (for example, the order of an image data size, the order of an examinee's deviation value, the order of an answer-density, for each test site, or the like) to display the data on the correct-or-incorrect judgement screen. For example, when the answer image data is rearranged in the order of an deviation value, the deviation value may be an examinee's total deviation value, or may be an examinee's deviation value by subject.

Next, an inputting unit 405 of the first grader terminal device 41 receives an input indicating judgement that an answer is correct (∘), an input indicating judgement that an answer is incorrect (x), an input indicating judgement that there is no answer (∨), a “grading-suspending flag”, or a “comment-requesting flag” for each answer image data. The memory unit 403 of the first grader terminal device 41 stores the received input indicating judgement that an answer is correct (∘), the received input indicating judgement that an answer is incorrect (x), the received input indicating judgement that there is no answer (∨), the received “grading-suspending flag”, or the received “comment-requesting flag” and the answer ID of each answer image data as grading result data while associating said input or flag with said answer ID.

The grading result data by the first grader terminal device 41 is transmitted to the server device 20 by a transmitting unit 402 of the first grader terminal device 41. In the server device 20, the grading result data is stored in the database unit 70. The grading result data stored in the database unit 70 has, for example, a configuration showed in FIG. 3. The grading result data comprises an answer ID, a value indicating a correct answer, a value indicating an incorrect answer, a value indicating no answer, a value indicating a grading-suspending flag, and a value indicating a comment-requesting flag. Among the grading result data, the grading result data in which the value indicating a correct answer is 1, the grading result data in which the value indicating an incorrect answer is 1, and the grading result data in which the value indicating no answer is 1 are data in which judgement as to whether an answer is correct or incorrect has been made. Among the grading result data, the grading result data in which the value indicating a grading-suspending flag is 1 and the grading result data in which the value indicating a comment-requesting flag is 1 are data in which judgement as to whether an answer is correct or incorrect has not yet been made. Thus, the grading result data in which the value indicating a grading-suspending flag is 1 and the grading result data in which the value indicating a comment-requesting flag is 1 need to be further judged as to whether an answer is correct or incorrect.

Post-grading processing in Step S105 comprises Step S105-1 and Step S105-2.

In Step S105-1, the server device 20 performs extraction processing. As a result, the grading result data which needs to be further judged as to whether an answer is correct or incorrect is extracted. The server device 20 extracts the grading result data in which the value indicating a grading-suspending flag is 1 and the grading result data in which the value indicating a comment-requesting flag is 1 as flagged data by reading the value indicating a grading-suspending flag and the value indicating a comment-requesting flag. The extracted flagged data is transmitted to the second grader terminal device 42 for further judgement as to whether an answer is correct or incorrect. The second grader terminal device 42 which received the flagged data stores the flagged data in a memory unit 403 of the second grader terminal device 42.

In Step S105-2, the second grader terminal device 42 processes the flagged data. In the processing of the flagged data, when the flagged data is data with a grading-suspending flag, an inputting unit 405 of the second grader terminal device 42 receives any of an input indicating judgement that an answer is correct (∘) and an input indicating judgement that an answer is incorrect (x) for the flagged data. When the flagged data is data with a comment-requesting flag, the inputting unit 405 of the second grader terminal device 42 receives a comment for the flagged data. Upon doing so, the inputting unit 405 of the second grader terminal device 42 may concurrently receive an input indicating judgement that an answer is correct (∘), or the inputting unit 405 of the second grader terminal device 42 may concurrently receive an input indicating judgement that an answer is incorrect (x). The memory unit 403 of the second grader terminal device 42 stores an answer ID of the flagged data and the received input indicating judgement that an answer is correct (∘) or the received input indicating judgement that an answer is incorrect (x) or the received comment as grading result data while associating said answer ID with said input or comment.

The grading result data by the second grader terminal device 42 is transmitted to the served device 20 by a transmitting unit 402 of the second grader terminal device 42. In the server device 20, the grading result data is stored in the database unit 70. The grading result data stored in the database unit 70 comprises a value indicating a correct answer, a value indicating an incorrect answer, a value indicating no answer, and a value indicating that a comment has been given. The server device 20 verifies that any of the value indicating a correct answer, the value indicating an incorrect answer, the value indicating no answer, and the value indicating that a comment has been given is 1 for all grading result data stored in the database unit 70. When any of the value indicating a correct answer, the value indicating an incorrect answer, the value indicating no answer, and the value indicating that a comment has been given is 1 for all grading result data stored in the database unit 70, the server device 20 determines that judgement as to whether an answer is correct or incorrect is completed for all grading result data stored in the database unit 70. When it is determined that judgement as to whether an answer is correct or incorrect is completed, the flow proceeds to Step S106.

In Step S106, the server device 20 performs grade processing. First, the server device 20 determines each examinee's scores, which is performed based on the grading result data stored in the database unit 70. The server device 20 determines scores of each examinee by extracting grading result data in which the value indicating a correct answer is 1 from the database unit 70 and summing up points of questions to which the extracted grading result data corresponds. Furthermore, the server device 20 may treat an answer to which a comment has been given as a correct answer. In this case, grading result data in which the value indicating a correct answer is 0 but the value indicating that a comment has been given is 1 may be extracted, and a point of a question to which the extracted grading result data corresponds may be added to the scores. In this manner, each examinee's scores are determined. Next, the server device 20 stores grade data comprising the grading result data, the determined scores of each examinee, and the comment given by the second grader terminal device 42 in the database unit 70.

In Step S107, the server device 20 receives a comment input. For example, the comment is inputted by a teacher in charge of the class of an examinee. The comment inputted by the teacher in charge of the class is stored in the database unit 70 while being associated with the grade data.

In Step S108, the examinee terminal 50 displays a test result. The test result comprising an examinee's grade data and the comment associated with the grade data is transmitted to the examinee terminal device 50, and an outputting unit of the examinee terminal device 50 displays the test result.

The grading result data by the second grader terminal device 42 may be transmitted from the server device 20 to the first grader terminal device 41. The outputting unit 406 of the first grader terminal device 41 presents the grading result data by the second grader terminal device 42 to the first grader. This enables the first grader of the first grader terminal device 41 to confirm how the second grader of the second grader terminal device 42 judged an answer to which the first grader inputted a grading-suspending flag. In this manner, giving feedback regarding how an answer for which a grader suspended grading was graded by another grader will lead to the education of the grader. This is expected to achieve a further educational effect when a person who judged whether an answer for which grading was suspended is correct or incorrect inputs a comment regarding the grounds for the judgement and concurrently feeds back the comment. Further, information on how many grading-suspending flags are inputted to which question may be fed back to a preparer of questions. That is because, it is considered that the more grading-suspending flags are inputted to a question, the better the question is, which makes examinees and graders think. The information regarding grading-suspending will also lead to the education of the preparer of questions.

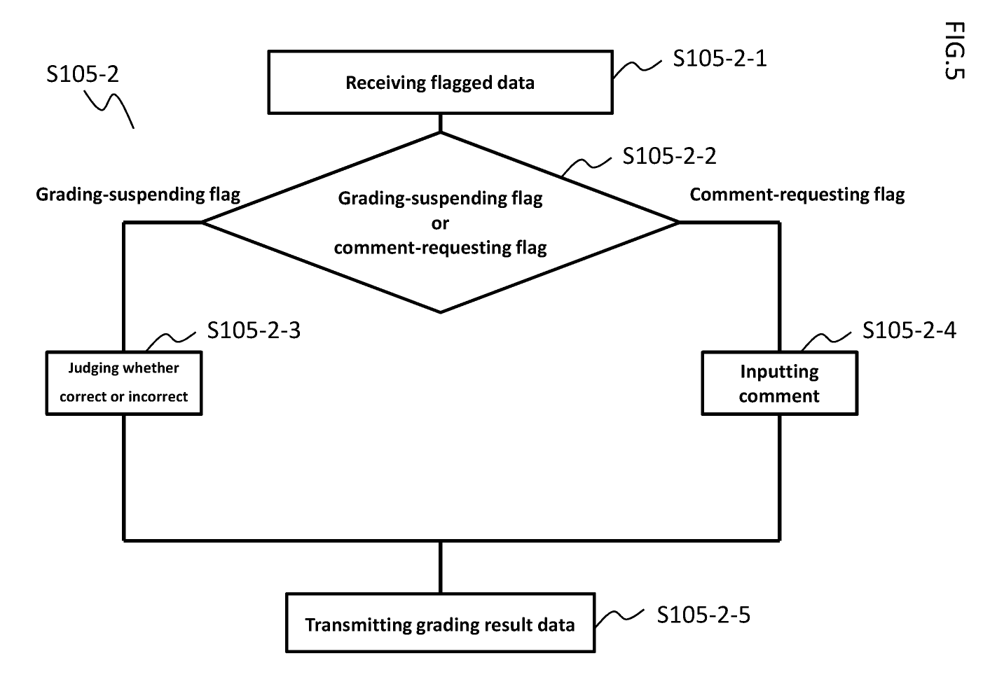

FIG. 5 shows one example of a flow of processing of flagged data executed in Step S105-2. This processing is executed by the second grader terminal device 42.

In Step S105-2-1, a receiving unit 401 of the second grader terminal device 42 receives flagged data.

In Step S105-2-2, a controlling unit 404 of the second grader terminal device 42 determines whether the received flagged data is data with a grading-suspending flag or data with a comment-requesting flag. This is determined by, for example, reading a value indicating a grading-suspending flag and a value indicating a comment-requesting flag in the flagged data.

When it is determined that the flagged data is data with a grading-suspending flag, the inputting unit 405 of the second grader terminal device 42 receives an input indicating judgement by the second grader as to whether an answer is correct or incorrect in Step S105-2-3. Before receiving the input indicating judgement by the second grader as to whether an answer is correct or incorrect, an outputting unit 406 of the second grader terminal device 42 displays a correct-or-incorrect judgement screen which enables the second grader to judge whether an answer is correct or incorrect. It does not matter how the flagged data is displayed on the correct-or-incorrect judgement screen. The flagged data may be arranged for each question to display the data on the correct-or-incorrect judgement screen, or may be arranged for each examinee to display the data on the correct-or-incorrect judgement screen. Alternatively, the flagged data may be rearranged in a particular order (for example, the order of an image data size, the order of an examinee's deviation value, the order of an answer-density, for each test site, or the like) to display the data on the correct-or-incorrect judgement screen. For example, when the flagged data is rearranged in the order of an deviation value, the deviation value may be an examinee's total deviation value, or may be an examinee's deviation value by subject.

Next, the inputting unit 405 of the second grader terminal device 42 receives any of an input indicating judgement that an answer is correct (∘) and an input indicating judgement that an answer is incorrect (x) for the flagged data. The memory unit 403 of the second grader terminal device 42 associates an answer ID of the flagged data with any of the received input indicating judgement that an answer is correct (∘) and the received input indicating judgement that an answer is incorrect (x) and stores them as grading result data.

When it is determined that the flag of the flagged data is a comment-requesting flag in Step S105-2-2, the second grader terminal device 42 receives a comment input by the second grader in Step S105-2-4. Before the second grader terminal device 42 receives the comment input by the second grader, the outputting unit 406 of the second grader terminal device 42 displays a comment inputting screen which enables the second grader to input a comment. It does not matter how the flagged data is displayed on the comment inputting screen. The flagged data may be arranged for each question to display the data on the comment inputting screen, or may be arranged for each examinee to display the data on the comment inputting screen. Alternatively, the flagged data may be rearranged in a particular order (for example, the order of an image data size, the order of an examinee's deviation value, the order of an answer-density, for each test site, or the like) to display the data on the comment inputting screen. For example, when the flagged data is rearranged in the order of an deviation value, the deviation value may be an examinee's total deviation value, or may be an examinee's deviation value by subject.

Next, the inputting unit 405 of the second grader terminal device 42 receives a comment for the flagged data. Upon doing so, the inputting unit 405 of the second grader terminal device 42 may concurrently receive an input indicating judgement that an answer is correct (∘), or the inputting unit 405 of the second grader terminal device 42 may concurrently receive an input indicating judgement that an answer is incorrect (x). The memory unit 403 of the second grader terminal device 42 associates an answer ID of the flagged data with the comment (and, if applicable, the input indicating judgement that an answer is correct (∘) or the input indicating judgement that an answer is incorrect (x)) and stores them as grading result data.

In Step S105-2-5, the transmitting unit 402 of the second grader terminal device 42 transmits the grading result data to the server device 20.

In the example shown in FIG. 5, the inputting unit 405 of the second grader terminal device 42 receives a comment in Step S105-2-4. However, when the second grader judges that it is not necessary to input a comment, the inputting unit 405 of the second grader terminal device 42 may not receive a comment. Instead, the inputting unit 405 of the second grader terminal device 42 can receive an input indicating judgement that an answer is incorrect (x). Alternatively, when the second grader requests a comment from another grader, the second grader terminal device 42 may not receive a comment. Upon doing so, the grading result data transmitted to the server device 20 remains not being judged as to whether an answer is correct or incorrect. Therefore, the server device 20 cannot determine that grading for all of the grading result data stored in the database unit 70 is completed, and thus flagged data is to be extracted again. The flagged data to be extracted is transmitted to another grader terminal device for further judgement as to whether an answer is correct or incorrect.

In the example shown in FIGS. 4-5, it was described that the flagged data extracted from the grading result data transmitted by the transmitting unit 402 of the first grader terminal device 41 is transmitted to the second grader terminal device 42. However, the transmission destination of the flagged data is not limited to the second grader terminal device 42. For example, the flagged data extracted from the grading result data transmitted by the transmitting unit 402 of the first grader terminal device 41 may be returned to the first grader terminal device 41, which makes it possible to give the first grader an opportunity to make judgement again after a series of grading is completed. Alternatively, the data with a grading-suspending flag may be transmitted to the second grader terminal device 42, and the data with a comment-requesting flag may be transmitted to the third grader terminal device 43.

In the example shown in FIGS. 4-5, it was described that the second grader terminal device 42 judges whether an answer is correct or incorrect, or inputs a comment for the flagged data extracted from the grading result data transmitted by the transmitting unit 402 of the first grader terminal device 41. However, the inputting unit 405 of the second grader terminal device 42 may receive a grading-suspending flag or a comment-requesting flag in the same manner as the inputting unit 405 of the first grader terminal device 41, instead of an input indicating judgement that an answer is correct (∘), an input indicating judgement that an answer is incorrect (x). When the inputting unit 405 of the second grader terminal device 42 receives a grading-suspending flag, the data received by the server device 20 from the second grader terminal device 42 may be transmitted to the third grader terminal device 43 and the judgement as to whether an answer is correct or incorrect, or inputting a comment may be performed on the inputting unit 405 of the third grader terminal device 43. In this manner, inputting units of a plurality of grader terminal devices can receive a plurality of flags for one answer image data.

### 4. Implementation Examples

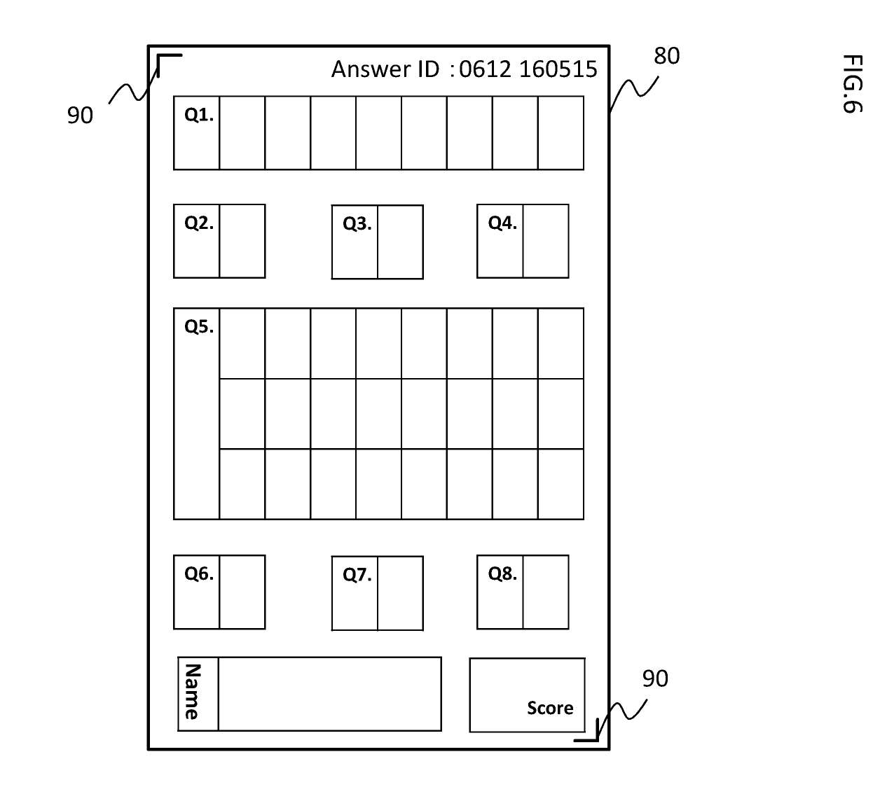

FIG. 6 shows one example of an answer sheet 80 of a test. The answer sheet 80 comprises an answer column for a multiple-choice question and an answer column for a descriptive question. In the example shown in FIG. 6, questions No. 2, No. 3, No. 4, No. 6, No. 7, and No. 8 are multiple-choice questions, and questions No. 1 and No. 5 are descriptive questions. A test question targeted by a computer system 10 may be a multiple-choice question, or may be a descriptive question.

When the test question is a multiple-choice question, it is sometimes unclear whether a child's hand-written answer is “ [symbol] (a)” or “ [symbol] (∘)” (that is, whether the child selects a choice “ [symbol] (a)” or selects a choice “ [symbol] (∘)”). In this case, a grader can ask another grader for judgement on the unclear answer by performing “grading-suspending” for the unclear answer.

When the test question is a descriptive question, a grader sometimes wavers in judgement as to whether an answer is correct or incorrect. In this case, the grader can ask another grader for judgement on the answer for which he/she wavers in judgement as to whether it is correct or incorrect by performing “grading-suspending” for the answer without making judgement. For example, when the test question is a descriptive question, partial scores may be given when an answer is partially correct although not completely correct. In this case, the grader sometimes wavers in judgement as to how many scores should be given as partial scores of the answer. In this case, the grader can ask another grader for judgement on the answer for which he/she wavers in judgement as to how many scores should be given as partial scores by performing “grading-suspending” for the answer without making judgement.

Furthermore, an ID of answers to examination and a marker 90 are pre-printed on the answer sheet 80 in the example shown in FIG. 6.

The ID of answers to examination is an identifier for identifying to which test the answer sheet 80 belongs. It is possible to automatically identify to which test the answer sheet belongs by reading the ID of answers to examination when scanning the answer sheet. As a result, a server device 20 can grasp the configuration of questions and the configuration of answer columns on the answer sheet based on the read ID of answers to examination.

When slanting image data is created as a result of the answer sheet 80 being slantingly scanned, the marker 90 is used as a criterion for correcting the orientation of the image data. In the example shown in FIG. 6, the marker 90 is placed as an L-shape marker in the upper left corner and the lower right corner of the answer sheet 80. However, the shape of the marker or the placement of the marker is not limited to the above. The marker 90 can have any shape and can be placed in any position of the answer sheet 80 as long as the marker can be used as a criterion for correcting the orientation of the image data.

The answer sheet 80 is not limited to the answer sheet shown in FIG. 6. For example, an answer sheet of any size can be used, and an answer sheet having any question configuration and any configuration of answer columns can be used as the answer sheet 80. For example, the answer columns of the answer sheet 80 may be vertical writing or horizontal writing. For example, the answer sheet 80 may not comprise an ID of answers to examination or marker 90.

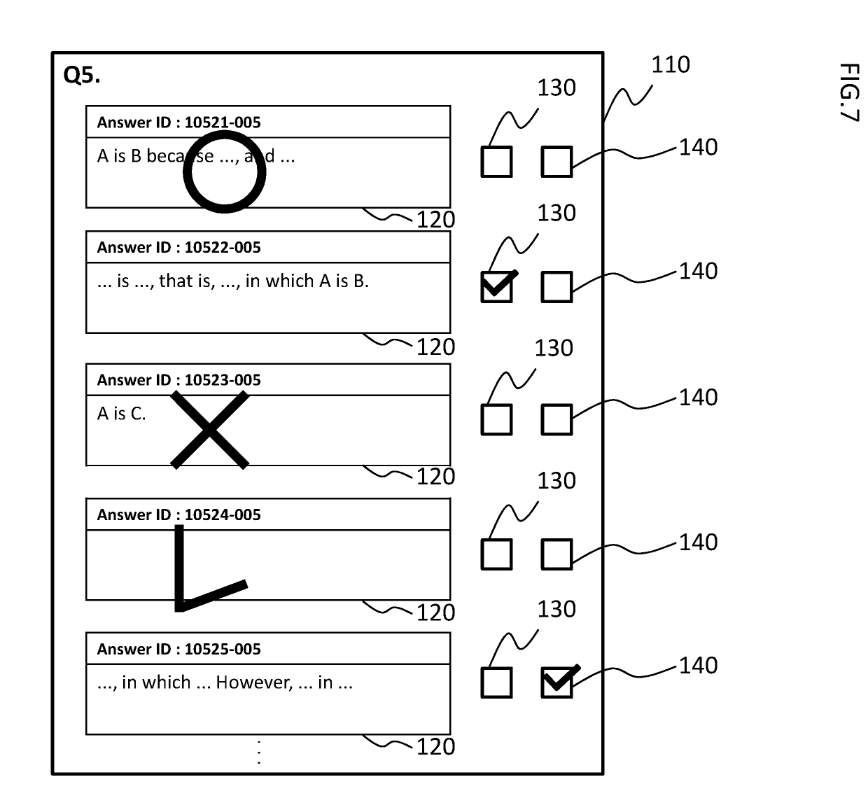

FIG. 7 shows one example of a screen 110 displayed on a display of a grader terminal device 40.

The screen 110 is, for example, a screen displayed on the display of the first grader terminal device 41 described with reference to FIGS. 4A and 4B. The screen 110 comprises: a region for displaying answer image data 120; a region for displaying a checkbox for grading-suspending 130; and a region for displaying a checkbox for comment-requesting 140. In the example shown in FIG. 7, the answer image data 120 for question No. 5 of each examinee is arranged and displayed on the screen 110. An answer ID has been given to each answer image data 120.

The grader can, for example, draw “∘” on the answer image data 120 of the screen 110 to present judgement that the answer is correct to the first grader terminal device 41. In the example shown in FIG. 7, the grader judges that an answer with answer ID “10521-005” is correct, and the judgement is presented to the first grader terminal device 41.

The grader can, for example, draw “x” on the answer image data 120 of the screen 110 to present judgement that the answer is incorrect to the first grader terminal device 41. In the example shown in FIG. 7, the grader judges that an answer with answer ID “10523-005” is incorrect, and the judgement is presented to the first grader terminal device 41.

The grader can, for example, draw “∨” on the answer image data 120 of the screen 110 to present judgement that there is no answer to the first grader terminal device 41. In the example shown in FIG. 7, the grader judges that there is no answer for the answer with answer ID “10524-005”, and the judgement is presented to the first grader terminal device 41.

The grader can, for example, check the checkbox for grading-suspending 130 displayed beside the answer image data 120 on the screen 110 to present judgement to perform “grading-suspending” to the first grader terminal device 41 without judging whether the answer is correct or incorrect. In the example shown in FIG. 7, the grader judges to perform “grading-suspending” without judging whether the answer with answer ID “10522-005” is correct or incorrect, and the judgement is presented to the first grader terminal device 41.

The marker can, for example, check the checkbox for comment-requesting displayed beside the answer image data 120 on the screen 110 to present a request to “give a comment” to the answer to the first grader terminal device 41. In the example shown in FIG. 7, the grader requested to “give a comment” to the answer with answer ID “10525-005”, and the request is represented to the first grader terminal device 41.

What was described in the example shown in FIG. 7 is the example wherein the grader presents judgement to perform “grading-suspending” or a request to “give a comment” to the first grader terminal device 41 for each answer image data 120 in addition to judgement as to whether the answer is correct, incorrect, or there is no answer. However, it does not matter in which manner said judgement or request is presented to the first grader terminal device 41. For example, the grader may collectively present judgement as to whether an answer is correct, incorrect, or there is no answer for all answers displayed on the screen 110 to the first grader terminal device 41.

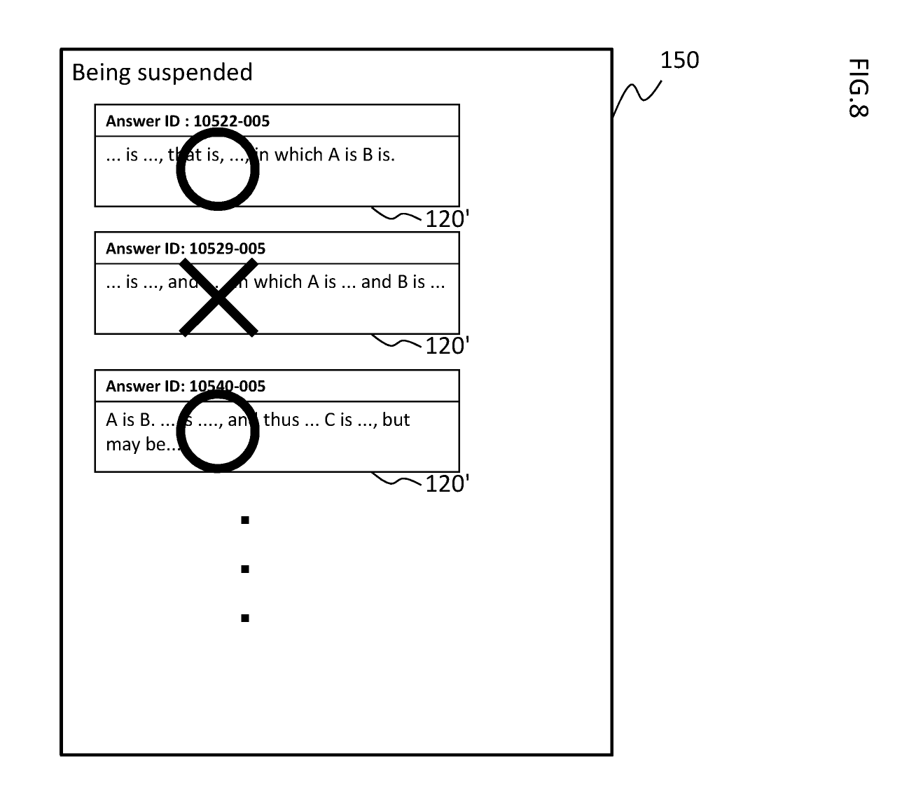

FIG. 8 shows one example of a screen 150 displayed on the display of the grader terminal device 40.

The screen 150 is, for example, a screen displayed on the display of the second grader terminal device 42 described with reference to FIGS. 4A and 4B. The screen 150 comprises a region for displaying answer image data 120′. The answer image data 120′ is data to which a grading-suspending flag has been given. In this regard, the data to which a grading-suspending flag has been given is data indicating an answer for which “grading-suspending” has been performed. In the example shown in FIG. 8, the answer image data 120′ for question No. 5 of each examinee to which a grading-suspending flag has been given is arranged and displayed on the screen 150. An answer ID has been given to each answer image data 120′.

The grader can, for example, draw “∘” on the answer image data 120′ on the screen 150 to present judgement that the answer is correct to the second grader terminal device 42. In the example shown in FIG. 8, the grader judges that the answer with answer ID “10522-005” and the answer with answer ID “10540-005” are correct, and the judgement is presented to the second grader terminal device 42.

The grader can, for example, draw “x” on the answer image data 120′ on the screen 150 to present judgement that the answer is incorrect to the second grader terminal device 42. In the example shown in FIG. 8, the grader judges that the answer with answer ID “10529-005” is incorrect, and the judgement is presented to the second grader terminal device 42.

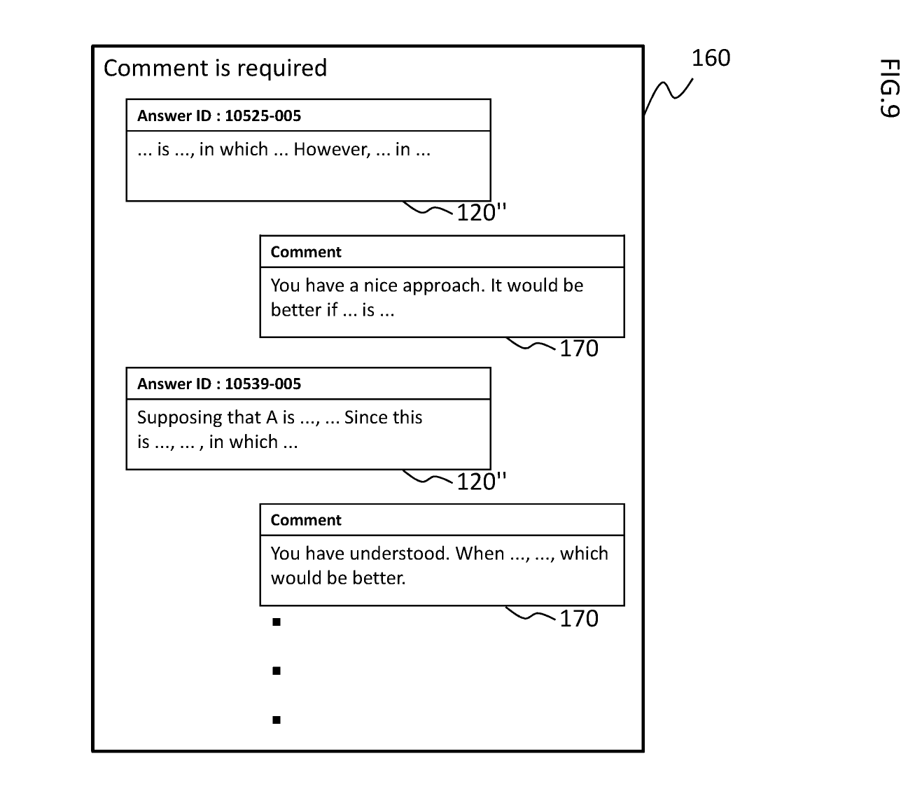

FIG. 9 shows one example of a screen 160 displayed on the display of the grader terminal device 40.

The screen 160 is, for example, a screen displayed on the display of the second grader terminal device 42 described with reference to FIGS. 4A and 4B. The screen 160 comprises a region for displaying answer image data 120″ and a region 170 for inputting a comment related to the answer image data 120″. The answer image data 120″ is data to which a comment-requesting flag has been given. In this regard, the data to which a comment-requesting flag has been given is data indicating an answer for which a request to “give a comment” has been made. In the example shown in FIG. 9, the answer image data 120″ for question No. 5 of each examinee to which a comment-requesting flag has been given is arranged and displayed on the screen 160. An answer ID has been given to each answer image data 120″.

For example, the grader inputs a comment in a region for inputting a comment related to the answer image data 120″ of the screen 160. In the example shown in FIG. 9, comments are inputted for the answer with answer ID “10525-005” and the answer with answer ID “10539-005”.

### 5. Other Functions for Assisting Grading of Answers to Examination

Functions for assisting grading of answers to examination other than those described above are described below.

In the pre-grading processing in Step S103, it is possible to further improve the efficiency in grading by performing character recognition processing of image data of an answer sheet. For example, when a test question is a multiple-choice question, it is possible to automatically grade an answer by performing character recognition processing because the answer is expressed by a single symbol (such as [symbol] (a), [symbol] (i), [symbol] (u) . . . ) or a numerical value (1, 2, 3 . . . ). It is possible to improve the ratio of character recognition by designating proposed characters when performing the character recognition processing. For example, it is possible to improve the ratio of character recognition by designating that proposed characters of an answer are 5 types of characters, “ [symbol] (a)”, “ [symbol] (i)”, “ [symbol] (u)”, “ [symbol] (e)”, and “ [symbol] (∘)”. Further, it is possible to improve the ratio of character recognition by improving training data for the character recognition processing. For example, it is possible to improve the ratio of character recognition when a child's hand-written character is subjected to the character recognition processing by utilizing the child's hand-written character as training data.

When the child's hand-written character is subjected to the character recognition processing, the character recognition processing sometimes fails due to an unclear character, and automatic grading cannot be performed. Even in that case, it is possible to lead to improvement of the efficiency in grading by deciding the probability of the character. For example, when a correct answer is “ [symbol] (a)”, the probability that characters which could not be character-recognized are “ [symbol] (a)” is determined. The characters are then rearranged in the order close to “ [symbol] (a)” or in the order far from “ [symbol] (a)”. This enables a grader to successively grade characters close to “ [symbol] (a)” or characters far from “ [symbol] (a)”, and to smoothly grade. Further, it is also possible to make use of information that “the character recognition processing failed” for education. For example, based on information that “the character recognition processing failed”, it is also possible to instruct an examinee who wrote the character to “write more carefully”.

The character recognition processing is also available for grading of a descriptive question. For example, when an answer is a combination of single symbols (“ [symbol] (u)”→“ [symbol] (e)”→“ [symbol] (a)”), it is possible to automatically grade by recognizing which character is referred to by each character and recognizing the order of each character. It is also possible to efficiently grade answers to examination in the form of describing a sentence by performing the character recognition processing. For example, some keywords (for example, five keywords) which should be comprised in a correct answer are prepared in advance, and the order of answers displayed to a grader is changed by classifying the answers based on the number of keywords comprised in the answers. For example, it is possible to assist grading by a grader by rearranging answer image data in descending order of the number of keywords comprised in an answer. That is because, the more keywords are comprised in an answer, the more highly likely the answer is correct, and the grader can collectively grade answers that are highly likely to be correct. The keywords may be extracted by performing character recognition for each character and deciding whether sequential characters fall under the keywords. For example, when a keyword consists of five characters, character recognition is performed for each character to decide whether the five characters fall under the keyword.

In the above embodiment, it was described that the second grader judges whether answer image data for which the first grader suspended grading is correct or incorrect in the post-grading processing in Step S105. However, the flow of grading is not limited to the above. For example, the whole or a part of grading result data which was judged whether it is correct or incorrect by the first grader may be judged again whether it is correct or incorrect by a plurality of other graders. For example, the whole or a part of grading result data which was judged whether it is correct or incorrect by a beginner-level grader may be judged again whether it is correct or incorrect by a middle-level grader. The accuracy of the grading result data of which grading has been changed by the middle-level grader may be confirmed by further another grader, and then said grading result data may be approved. In this manner, it is possible to prevent a mistake in grading and improve the grading quality. Further, it is also possible to lead to education of the beginner-level grader by feeding back the grading result data of which grading has been changed to the beginner-level grader.

In the post-grading processing in Step S105, answers to examination which cannot be unambiguously judged whether it is correct or incorrect may be stored in the database unit 70 as a dummy answers to examination among the flagged data to which a grading-suspending flag has been given. For example, flagged data to which a plurality of grading-suspending flags have been given by a plurality of grader terminal devices is considered as a dummy answers to examination which cannot be unambiguously judged whether it is correct or incorrect. It is possible to lead to education of graders by storing this dummy answers to examination and the grading result in the database unit 70 so that each grader can view them.

In the above embodiment, it was described that a comment for an examinee is inputted in the post-grading processing in Step S105. However, the comment is not limited to a comment for the examinee. For example, the comment may be a comment for a preparer of questions. It is possible to lead to education of the preparer by feeding back the comment for the preparer to the preparer.

In the grading of Step S104, an examinee's answer may be graded with an evaluation axis different from a correct answer, an incorrect answer, or no answer. For example, the examinee's answer may be graded using an evaluation means called Rubric proficiency assessment. In Rubric proficiency assessment, an approach to an answer, a descriptive method of an answer or the like is evaluated. For example, even when the answers of two examinees are both correct, there may be a difference based on Rubric proficiency evaluation. This makes it possible to give thorough learning guidance, not only evaluation based on scores.

### INDUSTRIAL APPLICABILITY

The present invention is useful as an invention providing a system and a program or the like which enables both improving the efficiency in grading and improving the quality of learning in grading.

### REFERENCE SIGNS LIST

10 computer system 10
20 server device
30 test site
301 scanner device
40 grader terminal device
50 examinee terminal device
60 Internet
70 database unit

1. A computer system for assisting grading of answers to examination, the computer system comprising an interface unit and a processor unit, the computer system being connected to a database unit, wherein the processor unit is configured to:
receive, via the interface unit, information indicating judgement made by a grader as to whether an answer of an examinee is correct or incorrect;
receive, via the interface unit, information indicating temporary judgement made by a grader not to judge whether an answer of an examinee is correct or incorrect, wherein the information indicating the temporary judgement includes information indicating comment-requesting judgement that indicates that it is requested to give a comment to the answer;
store the information indicating the judgement and the information indicating the temporary judgement in the database unit;
extract the answer for which the grader made the comment-requesting judgement that indicates that it is requested to give a comment from the database unit, based on the information indicating the comment-requesting judgement that indicates that it is requested to give a comment to the answer; and
receive, via the interface unit, a comment for the extracted answer.

2. The computer system of claim 1, wherein the processor unit is further configured to:
extract the answer for which the grader made the temporary judgement based on the information indicating the temporary judgement; and
receive, via the interface unit, information indicating judgement as to whether the extracted answer is correct or incorrect.

3. The computer system of claim 2, wherein the processor unit is further configured to transmit, via the interface unit, information indicating judgement as to whether the answer for which the grader made the temporary judgement is correct or incorrect to a terminal device of the grader.

4. (canceled)

5. The computer system of claim 1, wherein the processor unit is further configured to process the answer to which the comment has been received as a correct answer.

6. The computer system of claim 1, wherein the processor unit is further configured to receive, via the interface unit, information indicating judgement made by a grader that there is no answer of an examinee.

7. A program for assisting grading of answers to examination, the program being executed in a computer system, wherein the computer system comprises an interface unit and a processor unit, the computer system being connected to a database unit, and wherein the program, when executed, causes the processor unit to perform processing comprising:
receiving, via the interface unit, information indicating judgement made by a grader as to whether an answer of an examinee is correct or incorrect; and
receiving, via the interface unit, information indicating temporary judgement made by a grader not to judge whether an answer of an examinee is correct or incorrect, wherein the information indicating the temporary judgement includes information indicating comment-requesting judgement that indicates that it is requested to give a comment to the answer;
storing the information indicating the judgement and the information indicating the temporary judgement in the database unit;
extracting the answer for which the grader made the comment-requesting judgement that indicates that it is requested to give a comment from the database unit, based on the information indicating the comment-requesting judgement that indicates that it is requested to give a comment to the answer; and
receiving, via the interface unit, a comment for the extracted answer.

8. A method for assisting grading of answers to examination, the method being executed in a computer system, wherein the computer system comprises an interface unit and a processor unit, the computer system being connected to a database unit, and wherein the method comprising:
receiving, by the processor unit via the interface unit, information indicating judgement made by a grader as to whether an answer of an examinee is correct or incorrect; and
receiving, by the processor unit via the interface unit, information indicating temporary judgement made by a grader not to judge whether an answer of an examinee is correct or incorrect, wherein the information indicating the temporary judgement includes information indicating judgement that indicates that it is requested to give a comment to the answer;
storing, by the processor unit, the information indicating the judgement and the information indicating the temporary judgement in the database unit;
extracting, by the processor unit, the answer for which the grader made the comment-requesting judgement that indicates that it is requested to give a comment from the database unit, based on the information indicating the comment-requesting judgement that indicates that it is requested to give a comment to the answer; and
receiving, by the processor unit via the interface unit, a comment for the extracted answer.
